(19) United States
(12) Patent Application Publication
(10) Pub. No.: US 2008/0182145 A1
(43) Pub. Date: Jul. 31, 2008

(54) Basic cell structure for fuel cell equipped with sealing means

(75) Inventors: Thomas Nietsch, Les Milles (FR); Valery Chaudron, Manosque (FR); Lydie Tchicaya-Bouckary, Eguilles (FR); Olivier Verdu, New York, NY (US)

Correspondence Address: THELEN REID BROWN RAYSMAN & STEINER LLP, P. O. BOX 640640, SAN JOSE, CA, 95164-0640, US

(73) Assignee: HELON, AIX EN PROVENCE CEDEX (FR)

(21) Appl. No.: 11/820,830

(22) Filed: Jun. 21, 2007

(30) Foreign Application Priority Data
Jun. 30, 2006 (FR) 06 52745

(51) Int. Cl. H01M 8/02

(52) U.S. Cl. 429/26

(57) ABSTRACT

The invention makes it possible to provide a seal at the level of the contact between each membrane-electrode element (1) with the supply plates (10).

Sealing means produced either by means of a densification layer (20) or by means of a microporous material for forming the diffusion layers (3B, 4B), are arranged in the diffusion layers (3B, 4B) of the anode (3) and the cathode (4), respectively, opposite the open surface of the cooling channel (15) of each supply plate (10).

Application in PEM fuel cells.

### CROSS-REFERENCE TO RELATED PATENT APPLICATION OR PRIORITY CLAIM

This application claims the benefit of a French Patent Application No. 06-52745, filed on Jun. 30, 2006, in the French Intellectual Property Office, the disclosure of which is incorporated herein in its entirety by reference.

### FIELD OF THE INVENTION

The current problem of sustainable development and the predicted depletion of fossil fuel resources entail an ever-increasing need for energy sources that are, if possible, renewable and efficient.

Consequently, the invention relates to the field of fuel cells that can be industrially applied in both the civil and military sectors, and that concern both stationary installations and various transport means.

The stationary applications concern, for example, hospitals and other service buildings in which the possibility of a power supply interruption must be eliminated. The applications relating to transport concern the powering of trucks, trains, submarines and urban public transport vehicles, such as buses and trams.

### PRIOR ART AND STATED PROBLEM

The fuel cell is an electrochemical device that directly converts the chemical energy of a fuel into electrical energy. The principle of operation of this electrochemical generator is based on the electrochemical synthesis reaction of water. Numerous fuel cells are constituted by a series of basic stages also called electrochemical cells, each including a basic element constituted by two electrodes, an anode and a cathode, to which a combustion agent, for example air or oxygen, and a fuel, for example hydrogen, are continuously supplied, wherein said two gaseous elements remain separated by an ion-exchange membrane acting as an electrolyte. In the anode, the fuel undergoes catalytic oxidation releasing protons and electrons, in the case of a proton-exchange membrane-type fuel cell. The electrons produced circulate along the external electrical circuit, while the protons are transported from the electrolyte to the cathode, where they are recombined with the electrons and the oxygen. This cathodic reduction is accompanied by a production of water and the establishment of a potential difference between the two electrodes.

A number of types of fuel cells coexist and are differentiated by their electrolyte and their operation temperatures. For fuel cells operating at low temperatures (temperatures below 100° C.), the most advanced technology is represented by polymer electrolyte fuel cells. The invention described in this document uses a PEM (“Proton Exchange Membrane” fuel cell, of which the polymer electrolyte is a proton-exchange membrane.

The core of a fuel cell is constituted by an assembly of basic electrochemical cells, stacked one on top of another in an adequate number, so as to obtain the desired current and voltage values. Such a stack of basic cells of a fuel cell is commonly referred to as a “stack”.

In FIG. 1, each basic cell of a PEM fuel cell is composed of two separating plates 10 ensuring the supply of reactive gases, i.e. the fuel and the combustion agent, arranged on each side of a membrane-electrode assembly 1 called “EME”. This membrane-electrode assembly 1 includes a proton-exchange membrane 2 and two catalytic gas diffusion electrodes, namely an anode 3 and a cathode 4, each constituted by an active layer 3A, 4A and a diffusion layer 3B, 4B. In the anode 3, after diffusion through the diffusion layer 3B, the hydrogen, which is one of the two reactive gases, is catalytically oxidized in the active layer 3A, to yield protons and electrons. The electrons follow an external electrical circuit from the anode 3 to the cathode 4, shown diagrammatically at the tope of FIG. 1, but also the elements performing the separation of the reactant gases. In the cathode 4, the oxygen, the other reactive gas, undergoes a catalytic reduction and is recombined with the protons and the electrons to yield water.

In a stack of basic cells of a PEM fuel cell, the separating plates 10, called polar or bipolar plates, also perform the function of distributing reactive gases, namely oxygen or air and hydrogen, the function of collecting the electrons produced and the function of evacuating the reaction products, including water. Each separating plate 10 is in contact on one of its faces with the anode 3 of a basic cell of row N, while on the other face, it is in contact with a cathode 4 of a basic cell of row N+1.

The reactive gases therefore circulate on the two surfaces of each separating plate 10, by means of reactive gas circulation channels 14.

In addition, in the high-power fuel cells, a final function of the separating plates 10, i.e. the polar or bipolar plates, is the cooling of the stack of basic cells, by circulating a coolant between the different basic cells of the fuel cell. The coolant circulates in cooling channels 15, specifically designed and integrated in the separating plates 10. It should be noted that, at this stage, the coolant commonly used is water.

The cooling channels 15, where the coolant circulates, are conventionally integrated in specific plates arranged in the stack and intended solely for distribution of the coolant. In previous cases, the distributions of reactive gases and coolant have not been performed in the same plane or on the same plate. However, the insertion of specific cooling cells between a plurality of basic electrochemical cells increases the final volume of the stack, which constitutes a major disadvantage for transport-type applications, for example, in which it is desirable to save space.

To reduce the volume of the stack of basic cells, and as described in the French patent application FR 2 863 780, it is possible to use separating plates 10 in which the cooling channels 15 are found on the same face(s) as the channels for circulation of the reactive gases 14. Thus, the latter and the cooling channels 15 are coplanar. In addition, the cooling channel(s) 15 is (are) located on one or both faces of the separating plate 10.

In FIG. 2, if the cooling takes place on both faces of the same separating plate 10, it is possible that a single cooling channel 15 will provide the cooling simultaneously on both faces of the separating plate 10, owing to through-passages 16 of the plate passing from one face to the other. The separating plate 10 then includes a plurality of through-holes 16 in the cooling channel 15. At the periphery of the separating plate 10, holes 11 and 12 for supplying reactive gases and holes for supplying and evacuating the coolant 13 are noted.

There is then the problem of sealing the reactive gases from the coolant through the diffusion layers referenced 3B and 4B, respectively, on the anode 3 and the cathode 4 of FIG. 1. The problem is raised, to a lesser extent, on each side of the separating plate 10, due to the piercing of the latter in order to obtain the through-passages 16. Finally, there is also the problem of the seal between one reactive gas and the other on each side of the separating plate 10.

The goal of the invention is therefore to overcome this disadvantage by restoring the function of separation of the reactive gases, at the level of the separating plate 10, and to separate the reactive gases from the water at the level of the diffusion layers 3B and 4B of the anode 3 and the cathode 4 of each basic cell.

### SUMMARY OF THE INVENTION

To this end, the main object of the invention is a basic fuel cell structure including:
membrane-electrode assembly with planar contact surfaces, on its two diffusion layers, and
a separating plate of which at least one surface for circulation of coplanar channels for distribution of reactive gases and coolant is in contact with at least one planar contact surface of the adjacent membrane-electrode assembly, and
sealing means between the reactive gas circulation channel and the at least one cooling channel.

According to the invention, the sealing means are at least superficial and are located at least at the level of the surface of each diffusion layer constituting the contact surface, in contact with the circulation surface of the separating plate, opposite the cooling channels.

A first embodiment of the invention consists of performing a densification of the superficial layer of each contact surface of the membrane-electrode assembly, either at the surface, or at a certain thickness.

This densification can be performed by means of an adhesive, for example by means of a glue, or a thin plate.

A second embodiment consists of producing the densification layer by means of a hydrophobic material added to the diffusion layer at a certain thickness.

Finally, a third embodiment of the invention consists of using a microporous material to constitute the two diffusion layers each constituting a contact surface with the membrane-electrode assembly.

### BRIEF DESCRIPTION OF THE DRAWINGS

The invention and its various technical features can be better understood on reading the following description, accompanied by the three figures, respectively showing:

FIG. 1: a partial cross-section of the structure of a basic fuel cell according to the prior art;

FIG. 2: the general diagram of a distribution surface of a separating plate according to an embodiment of the prior art in which the cooling channels and the reactive gas distribution channels are coplanar, and

FIG. 3: in a cross-section, the basic cell structure according to the invention.

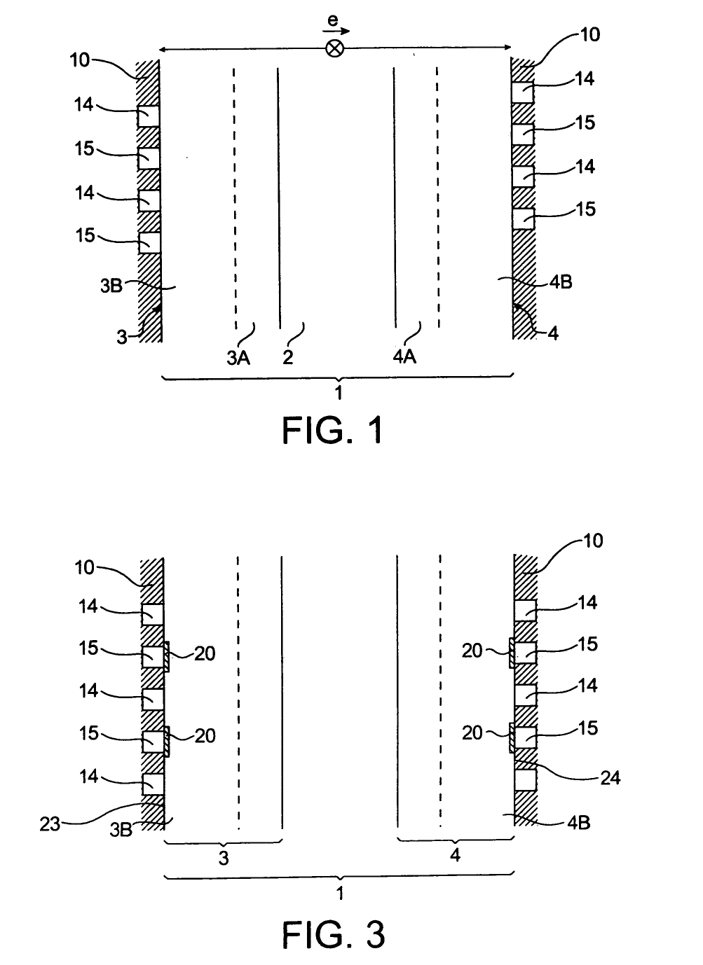

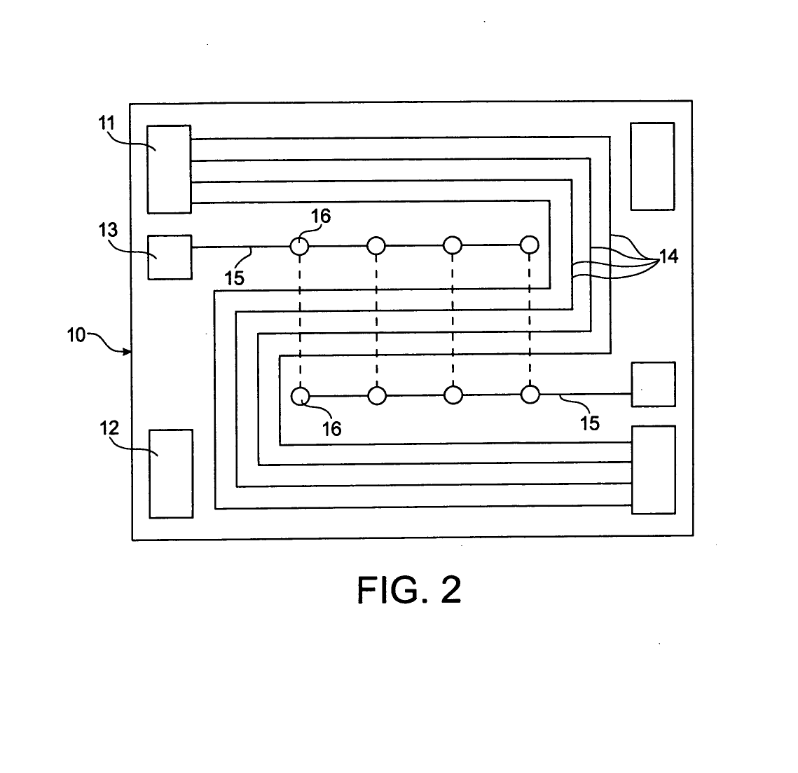

### DETAILED DESCRIPTION OF THREE EMBODIMENTS OF THE INVENTION

In FIG. 3, each basic cell is equipped with the sealing means for each membrane-electrode element 1, in particular at the level of the diffusion layers 3B and 4B of the electrodes, respectively the anode 3 and the cathode 4 of each basic cell. The objective is to prevent the coolant, for example water, from mixing with one or both of the reactive gases, for example, the oxygen and the hydrogen, or to prevent said two reactive gases from mixing with each other.

It is noted that these sealing means are applied to supply plates 10 for which a cooling channel 15 is used, which cooling channel 15 passes through the distribution plate 10, but also to supply plates each comprising at least one cooling channel 15 on each of its distribution surfaces.

As shown in FIG. 3, the reactive gas supply channels 14 and cooling channels 15 are coplanar and open out on the same plane, which is the contact plane between each supply plate 10 and the planar contact surface 23 of the anode 3 and the contact surface 24 of the cathode 4. It is therefore reasonable to assume that, without the sealing means, some of the reactive gases circulating in the reactive gas circulation channel(s) 14 could pass into this contact plane to reach the cooling channel 15.

The proposed solution consists of installing sealing means at the level of the surface or at a certain thickness of the diffusion layer 3B of the anode 3 and the diffusion layer 4B of the cathode 4, opposite the cooling channel 15. Indeed, in two embodiments of the invention, opposite each cooling channel 15, a densification layer 20 is provided, with a width greater or not greater than that of the cross-section of the cooling channel 15 and extending or not on each side. It is thus understood that, if this densification layer 20 is impermeable or has equivalent properties with respect to liquids or reactive gases, the sealing of the coolant, for example water, is ensured with respect to the reactive gas circulation channels 14.

Such a densification layer 20 can be made in various ways, for example by means of an adhesive placed on the surfaces 23 and 24, respectively, of the diffusion layers 3B and 4B of the anode 3 and the cathode 4. Of course, this adhesive must be placed opposite the cooling channel 15, as shown by the sealing layers 20 in FIG. 3. It is noted that the adhesive material can be in the form of a glue, a film or a thin plate. A second solution consists of producing the densification layer 20 by means of a hydrophobic material, placed more precisely on the superficial layer 23 of the diffusion layer 3B of the anode 3 and on the superficial layer 24 of the diffusion layer 4B of the cathode 4. Such a hydrophobic material can be polyvinylidene fluoride (PVDF).

The third solution proposed for producing sealing means according to the invention consists of saturating each diffusion layer made of a microporous material, so as to coat, among other things, the entire open surface of the cooling channel 15. Such a diffusion layer made of a microporous material is then formed with a multitude of micropores having a small diameter, on the order of a micron, allowing the passage of gas particles but blocking the passage of liquid drops.

It is noted that these sealing means at the level of the cooling channel 15 are independent of the other materials and seals used in the stacking of basic cells of a fuel cell. These are in particular the external seals always present on the supply plates not shown in the figures of this patent application.

1. Basic cell structure of a fuel cell including:
a membrane-electrode assembly (1) with two planar contact surfaces (23, 24), on its two diffusion layers (3B, 4B),
a supply plate (10) placed on each side of the membrane-electrode assembly (1) having a distribution surface comprising reactive gas circulation channels (14), and wherein at least one cooling channel (15) is in contact with the contact surface (23, 24) of the membrane-electrode assembly (1), and
sealing means between the reactive gas circulation channel (14) and the at least one cooling channel,
characterised in that the sealing means are at least superficial and are located at least at the level of the surface of the diffusion layer (3B) of the anode (3) and the diffusion layer (4B) of the cathode (4) of the membrane-electrode assembly (1), at least opposite the cooling channel (15) of each supply plate (10).

2. Structure according to claim 1, characterised in that the sealing means are constituted by a densification layer (20) placed opposite the cooling channel (15), at a certain thickness of the surface of the diffusion layer (3B) of the anode (3), and the diffusion layer (4B) of the cathode (4).

3. Structure according to claim 2, characterised in that the densification layer (20) is made with an adhesive material.

4. Structure according to claim 3, characterised in that the adhesive of the densification layer (20) is made of a glue.

5. Structure according to claim 3, characterised in that the adhesive of the densification layer (20) is made with a thin plate.

6. Structure according to claim 1, characterised in that the sealing means are constituted by a densification layer (20) placed opposite the cooling channel (15), at a certain thickness of the diffusion layer (3B) of the anode (3), and the diffusion layer (4B) of the cathode (4).

7. Structure according to claim 6, characterised in that the densification layer (20) is made with a hydrophobic material.

8. Structure according to claim 1, characterised in that the sealing means are made with a microporous material constituting the diffusion layer (3B) of the anode (3) and the diffusion layer (4B) of the cathode (4).
